(19) United States
(12) Patent Application Publication
(10) Pub. No.: US 2002/0095347 A1
(43) Pub. Date: Jul. 18, 2002

(54) Network-based method and system for selecting shipping carrier

(76) Inventor: Carol Cummiskey, Wethersfield, CT (US)

Correspondence Address: John S. Beulick, Esq., Armstrong Teasdale LLP, Suite 2600, One Metropolitan Sq., St. Louis, MO, 63102, US

(21) Appl. No.: 09/761,948

(22) Filed: Jan. 17, 2001

(51) Int. Cl. G06F 17/60

(52) U.S. Cl. 705/26

(57) ABSTRACT

A network-based method for facilitating a selection of at least one shipping carrier, using a network-based system including a server and at least one device connected to the server via a network. The method includes receiving shipping information, comparing the received shipping information against pre-stored information, selecting at least one shipping carrier which matches the received shipping information; and displaying an optimum shipping carrier based on the shipping information. The method further provides the user with a maintenance capability to update shipping carrier information.

### BACKGROUND OF THE INVENTION

This invention relates generally to computer network-based systems and more particularly to a network-based method and system for identifying shipping carriers and costs associated therewith.

With many different types of carriers, shipping methods and routes, it is often difficult for a customer or an internal user to determine a specific type of shipping method that meets the shipping objectives and yet is cost effective. Rates vary significantly among different carriers depending on the service and the segment in which different carriers specialize. Not having a cost effective method in selection of a carrier could cost a substantial sum to a corporation that conducts business multi-nationally.

Therefore, it would be desirable to quickly determine an optimum shipping method that should be utilized for a given size of the package and a destination. Additionally, it would be desirable to instantaneously determine if an alternative method exists for the same parameters and the comparative costs associated with it.

### BRIEF SUMMARY OF THE INVENTION

In an exemplary embodiment, a shipping carrier selection system allows users to select at least one optimum shipping method over the Internet. The system allows both experienced and novice users to select a method that is cost effective and also provides alternative methods that may reduce shipping costs.

A method for selecting at least one shipping carrier, in one embodiment, includes utilizing a network-based system comprised of a server coupled to a centralized database and at least one client system connected to the server via a network. The method includes authenticating a user based on a pre-defined criteria, and launching at least one of a shipping wizard to select an optimum shipping method and a maintenance wizard to maintain the centralized database, based on the user selection. In yet another embodiment, the method for facilitating selection of a shipping carrier includes accessing a maintenance user interface after a user has been authenticated based on a pre-defined criteria and providing capabilities to the user to maintain the centralized database.

In yet another exemplary embodiment, the network-based method for facilitating selection of at least one shipping carrier, using a network-based system includes a server and at least one device connected to the server via a network. The method includes receiving shipping information, comparing the received shipping information against pre-stored information, selecting at least one shipping carrier which matches the received shipping information; and displaying an optimum shipping carrier based on the shipping information. The method further provides the user with a maintenance capability to update shipping carrier information.

### BRIEF DESCRIPTION OF THE DRAWINGS

FIG. 1 is a block diagram of a system in accordance with one embodiment of the present invention;

FIG. 2 is an expanded version block diagram of an exemplary embodiment of a server architecture of an alternative system;

FIG. 3 is a flow diagram of a network-based method for selecting a shipping carrier;

FIG. 4 is an exemplary embodiment of a Home Page of a Shipping System displayed by the system after the user has logged on to the system;

FIG. 5 is an exemplary embodiment of an Input Interface;

FIG. 6 is an exemplary embodiment of a user interface displaying an optimum shipping method;

FIG. 7 is an exemplary embodiment of a user interface displaying alternative options to the user;

FIG. 8 is an exemplary embodiment of a user interface displaying the user's final selection;

FIG. 9 is an exemplary embodiment of a user interface displaying the user's selected carrier website to facilitate printing of a label;

FIG. 10 is an exemplary embodiment of a Maintenance Page of the shipping wizard displayed by the system after the user has logged on to the system;

FIG. 11 is an exemplary embodiment of a first segment of a New Carrier Definition user interface downloaded and displayed by server system to register a new carrier when the user has selected Register a new carrier hypertext link shown in FIG. 10;

FIG. 12 is an exemplary embodiment of a Modify a carrier user interface downloaded and displayed by server system to allow the maintenance user to modify a carrier when the user has selected “Modify Existing Carrier” hypertext link shown in FIG. 10;

FIG. 13 is an exemplary embodiment of a user interface downloaded and displayed by the server system to allow the maintenance user to select a specific function when the user has selected “Show details” button shown in FIG. 12;

FIG. 14 is an exemplary embodiment of a user interface that provides the user with a capability to modify or delete a specific location relating to a specific carrier identified;

FIG. 15 is an exemplary embodiment of a user interface that provides the user with a capability to add/edit departments;

FIG. 16 is an exemplary embodiment of a user interface that provides the user with a capability to add/edit a new maintenance user; and

FIG. 17 is an exemplary embodiment of a user interface that provides the user with various metrics related to usage of the system.

### DETAILED DESCRIPTION OF THE INVENTION

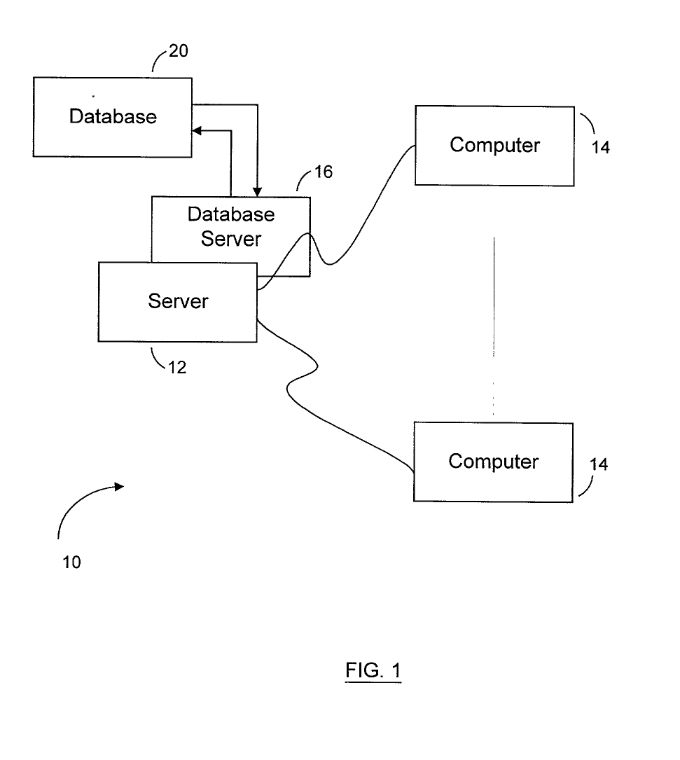

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server 12 includes a database server 16 connected to a centralized database 18 containing information pertaining to various shipping carriers, flat rates, rates based on destination and various shipping alternatives and other related information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

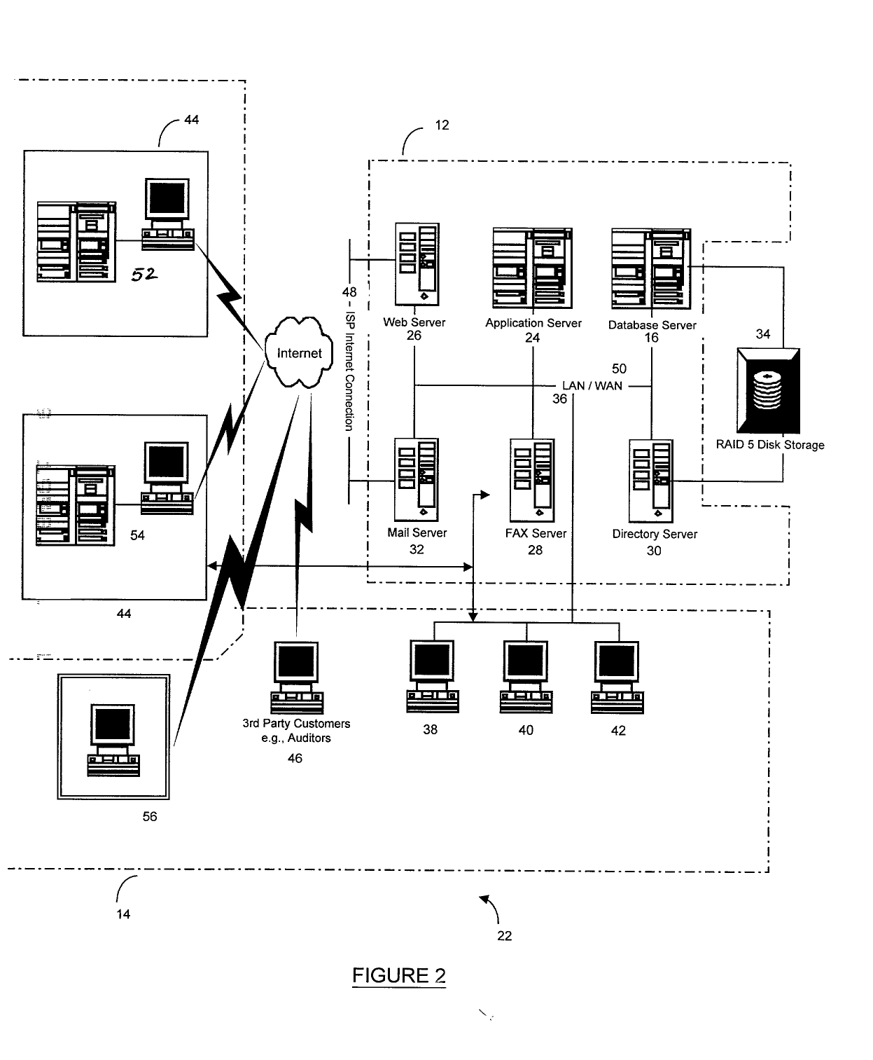

FIG. 2 is an expanded version block diagram of an exemplary embodiment of a server architecture of a system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 52 can access server sub-system 12. One of user devices 14 includes a workstation 54 located at a remote location. Workstations 52 and 54 are personal computers having a web browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

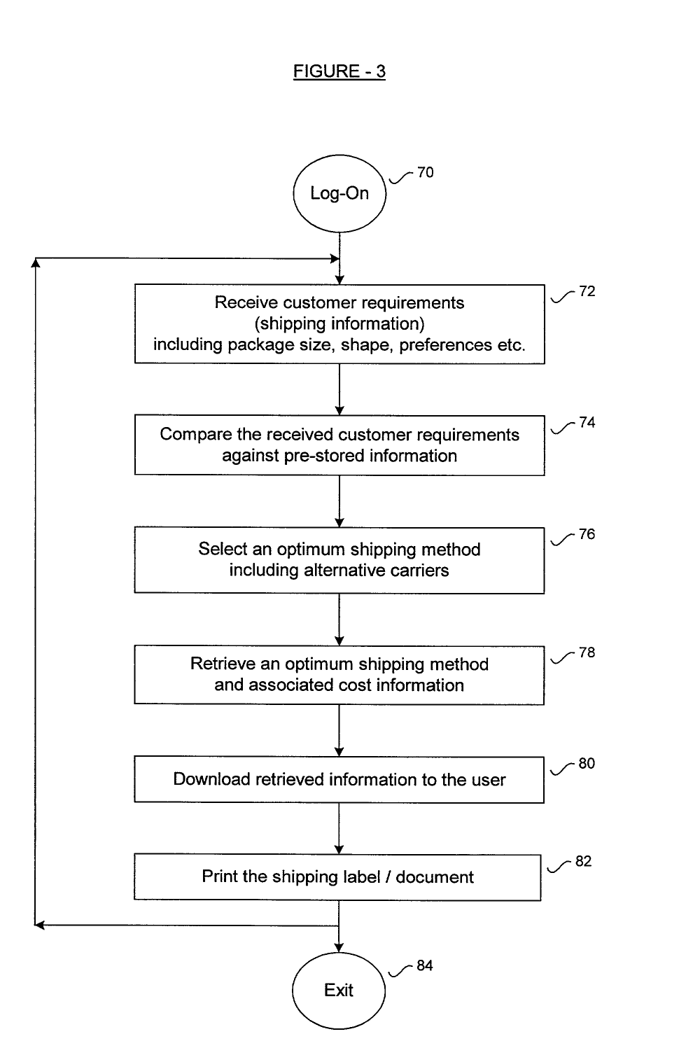

FIG. 3 is a flow diagram 68 for a network-based method for selecting an optimum shipping alternative. In one embodiment, the network-based method includes logging 70 onto a home page of the application. System 10 (shown in FIG. 1) receives 72 customer requirements including a package size, shipping preferences, etc. from a user. In one embodiment, the user inputs the information into a device (such as device 14 shown in FIG. 1) which transmits the information to a server (such as server 12 shown in FIG. 1). In another embodiment, the customer requirements information is received from the user via a graphical user interface.

The received customer requirement information includes customer specific requirements. Exemplary customer requirements include, but are not limited to, a package type, an origin of the package, a destination of the package, a latest delivery date, a latest time by which the package has to be delivered, an estimated weight of the package and a response to a question which deals with the specific size of the package.

Based on the initial requirements, server 12 compares 74 the received customer requirements to pre-stored information accessible by server 12. In one embodiment, the pre-stored information is stored in a database that resides on server 12. In an alternative embodiment, the pre-stored information is stored in a database remote from server 12. In yet another embodiment, all pre-stored logic tables and data structures are stored at various different servers and retrieved as necessary. Alternatively, pre-stored logic tables and data structures are downloaded dynamically from remote servers of different carriers as necessary. The pre-stored information includes information on various types of shipping carriers, their rates for specific destinations, delivery schedules, and other related information. Server 12 compares the user provided information to the pre-stored information to determine if any prestored information contained in the database satisfy the customer requirements submitted by the user.

System 10 then evaluates the information supplied by the user and selects 76 an optimum shipping method that meets or exceeds the customer requirements. System 10 identifies pre-stored information that matches the information entered by the user and selects 76 an optimum shipping method and a carrier. System 10 retrieves 78 and downloads 80 requested information relating to the optimum shipping method and the shipping carrier. In one embodiment, downloaded information includes a shipping carrier, a rate, a shipping method, and a delivery time. In an alternative embodiment, the downloaded information includes an alternative shipping method that is cost effective to the one that is initially recommended. Under this embodiment, the system further includes a name of a shipping carrier, a rate, a shipping method, a delivery time, and a percentage savings over the optimum method. Once the customer accepts the shipping method, the customer prints 82 a shipping label from the shipping carrier's web site. The customer may continue with another package or exit 84 from the system.

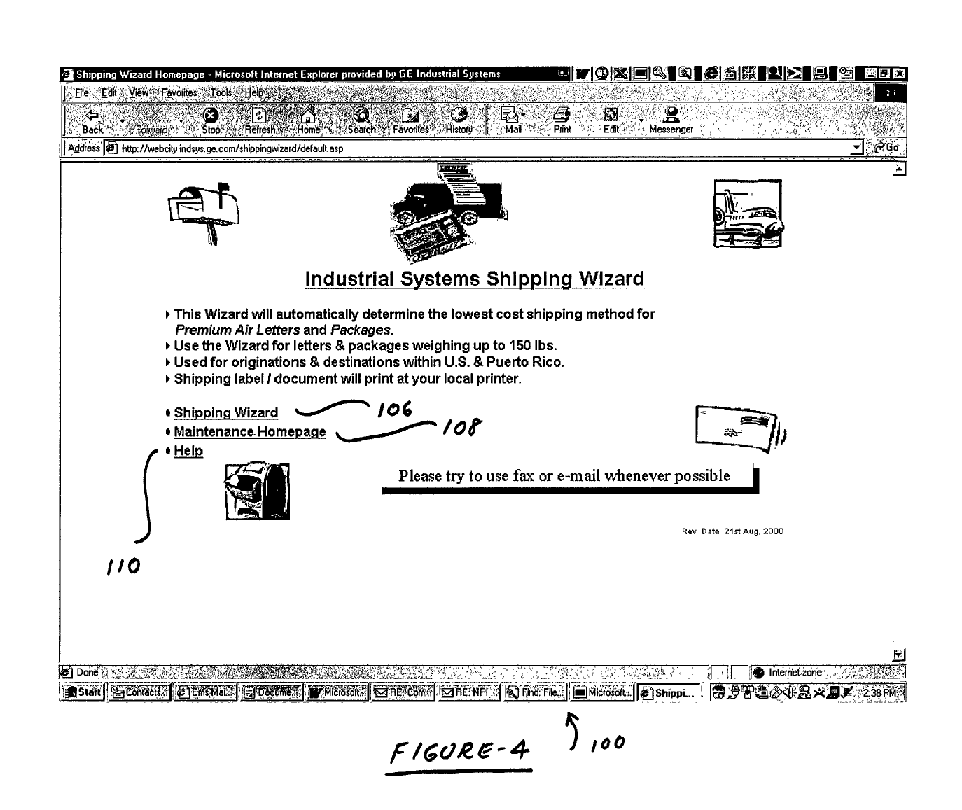

FIG. 4 is an exemplary embodiment of a Home Page 100 of a Shipping System displayed by the system after the user has logged on to the system. Home page 100 provides information about the shipping wizard and hypertext links to a Shipping Wizard module 106, a Maintenance Home Page 108 and a Help file 110. Shipping Wizard module 106 enables user to query for the optimum shipping method and print the labels. Maintenance Home Page 108 provides various system maintenance capabilities to an authorized system administrator and a support staff.

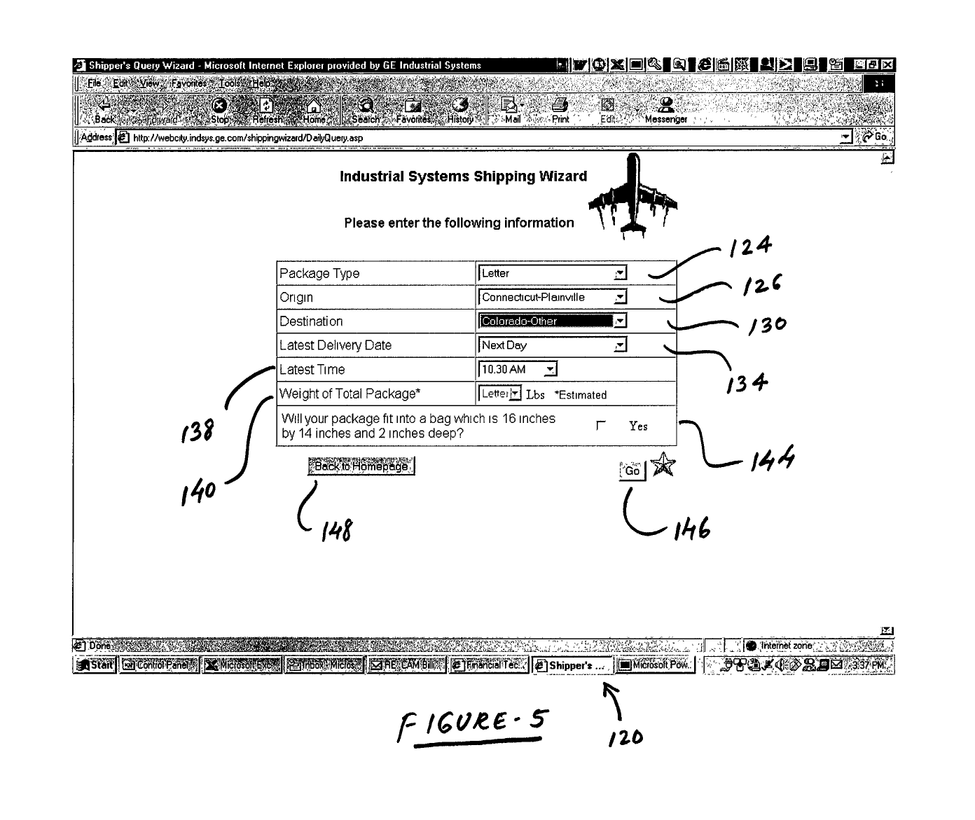

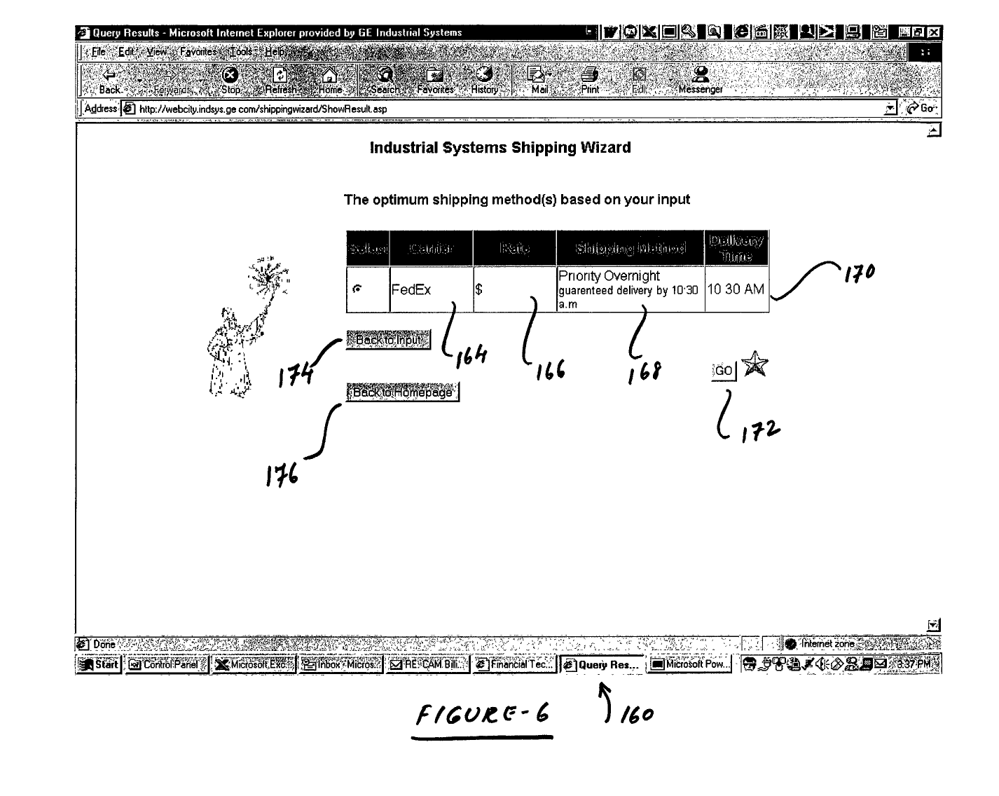

FIG. 5 is an exemplary embodiment of an Input Interface 120. To obtain the optimum method for shipping a package, the user selects a package type 124 (whether Letter or Other), place of origin 126 (From where the package is being sent), a destination 130 (To Where the Package is being sent), a Latest delivery date 134 (by when user wants the package delivered), a Latest time 138 and, a Weight of the package 140. The user may also select a bag option by checking a check box 144 adjacent to the message “Does the package fit into a bag 16 inches long by 14 inches wide and 2 inches deep?”. Once the user provides the details, the user selects a “Go” button 146, which displays the results (shown in FIG. 6) including the optimum shipping method. A “Back to Home Page” 148 takes the user back to home page user interface 100 shown in FIG. 4.

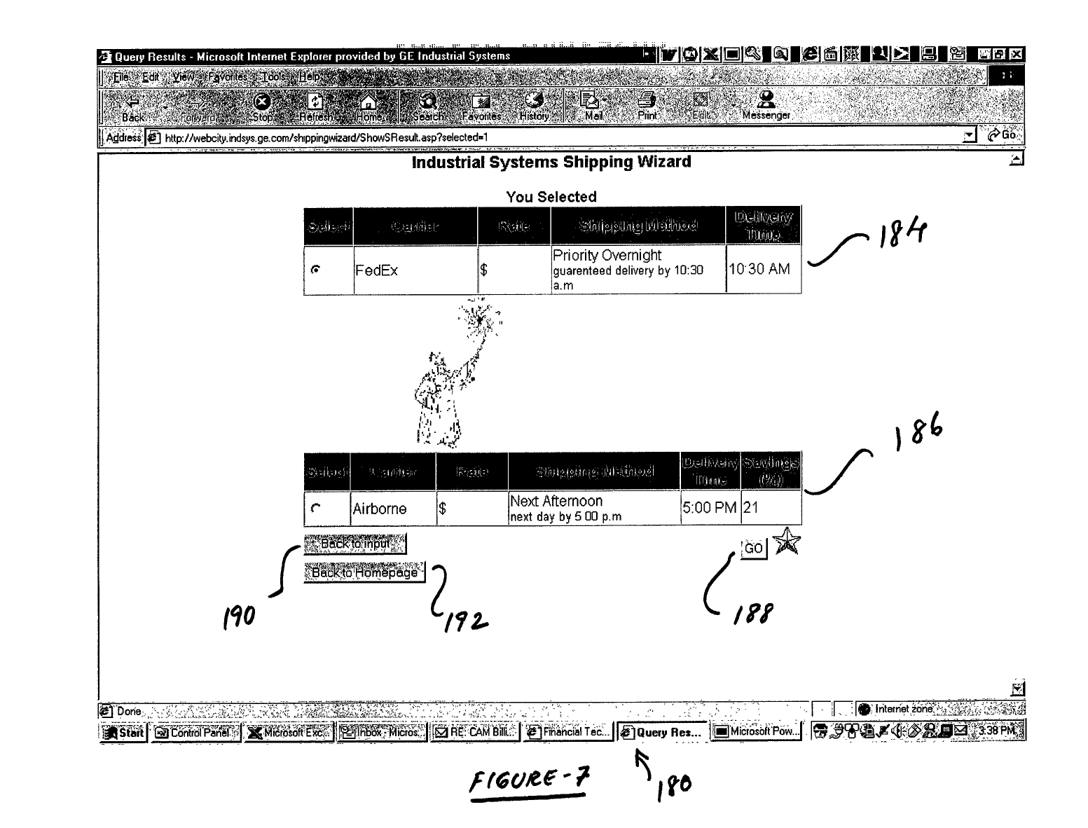

FIG. 6 is an exemplary embodiment of a user interface 160 displaying an optimum shipping method. User interface 160 displays a Carrier 164, a Rate 166, a Shipping Method 168 and Delivery Times 170 details of the optimum method. Once the user selects a “Go” button 172 to complete the query, the system displays next inexpensive options (in terms of rate) available taking into consideration latest time of delivery 138 (shown in FIG. 5), as shown in FIG. 7. A “Back to Input” button 174 directs the user to the user interface displayed in FIG. 5. A “Back to Home Page” 176 takes the user back to home page user interface 100 shown in FIG. 4.

FIG. 7 is an exemplary embodiment of a user interface 180 displaying alternative options to the user. User interface 180 displays a shipping method 184 based on the user's preference, as well as an alternative shipping method 186. For example, if the user selects 10:00 AM delivery option, the system will present to the user with a 12:00 PM, 3:00 PM or 5:00 PM delivery options along with first selected shipping method 184 option by the system. The user has an option to select any of the options presented on user interface 180. The user selects a “Go” button 188 to proceed to a next step. A “Back to Input” button 190 directs the user to the user interface displayed in FIG. 5. A “Back to Home Page” button 192 takes the user back to home page user interface 100 shown in FIG. 4.

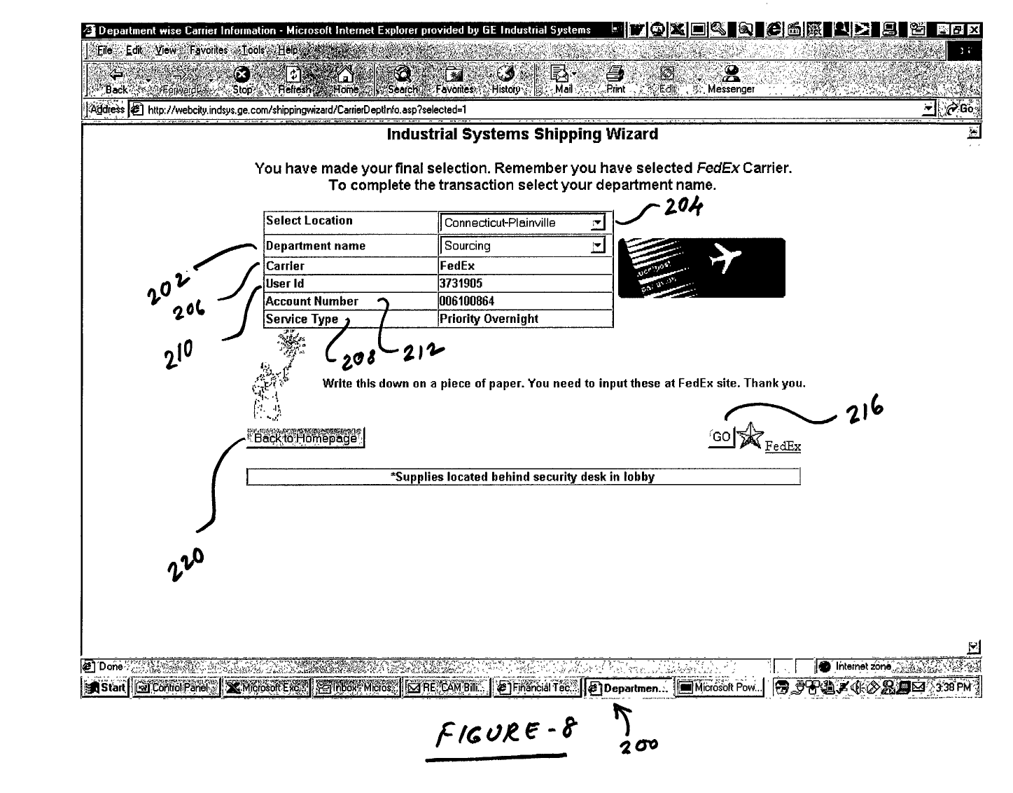

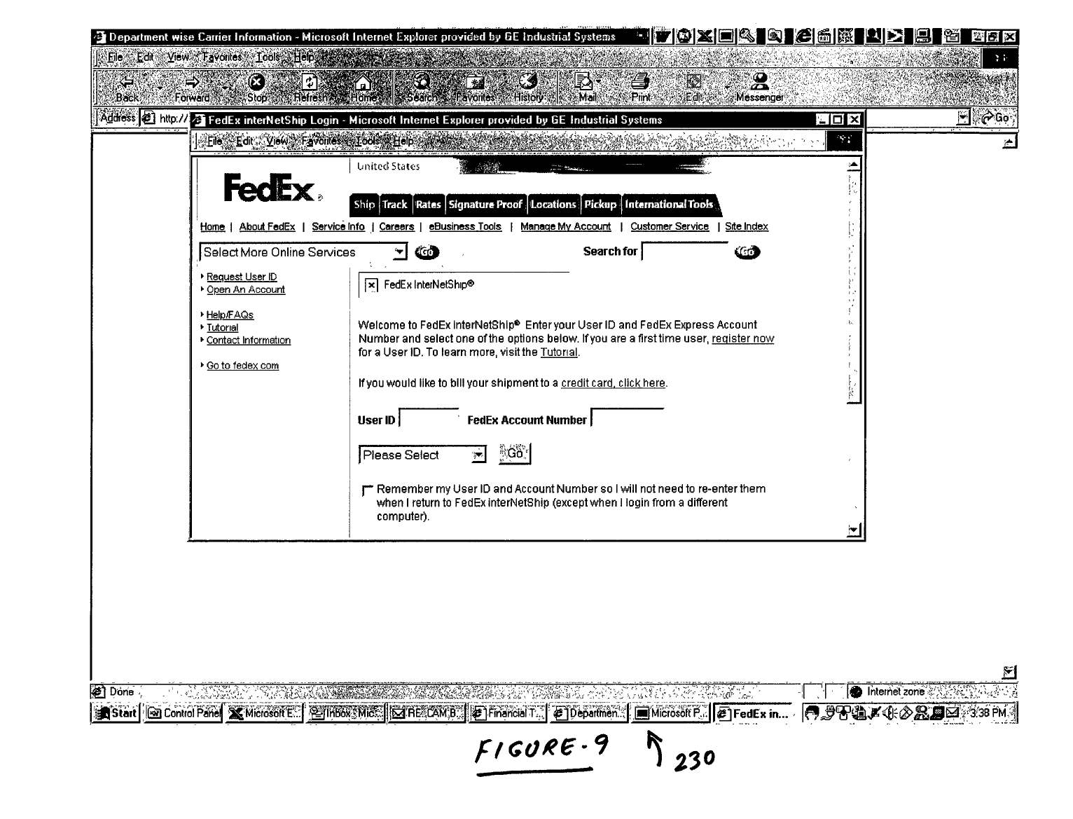

FIG. 8 is an exemplary embodiment of a user interface 200 displaying the user's final selection. To complete the transaction, the user is requested to furnish a department name 202 and a location 204 from a plurality of pull down menus. Once the user provides department name 202 and location 204, the system displays a carrier name 206, a service type 208, a User ID 210, a Password (not shown) and an Account number 212 (if exists) for department 202 of selected carrier 206. The information downloaded and displayed by system 10 is useful while preparing a shipment at the carrier's website. Once the user selects a “Go” button 216, the system downloads and displays to the user the website of the carrier (if available) or a user interface (shown in FIG. 9) where the user submits the shipment address details and prints a label on the local printer. A “Back to Home Page” button 220 takes the user back to home page user interface 100 shown in FIG. 4.

FIG. 9 is an exemplary embodiment of a user interface 230 displaying the user's selected carrier website to facilitate printing of a label. To complete the transaction, the user inputs requested information to allow the system to generate and print the shipping label. If the carrier does not have a website, the user is directed to an address page (not shown) where the user fills in “From Address” and “To Address” details. Once done, the user selects a “Generate label” button (not shown). The system then shows the shipping label on the screen. A “Print” button (not shown) is provided to print the label. The user selects the print button to print the label on the local printer or through a network printer, if configured.

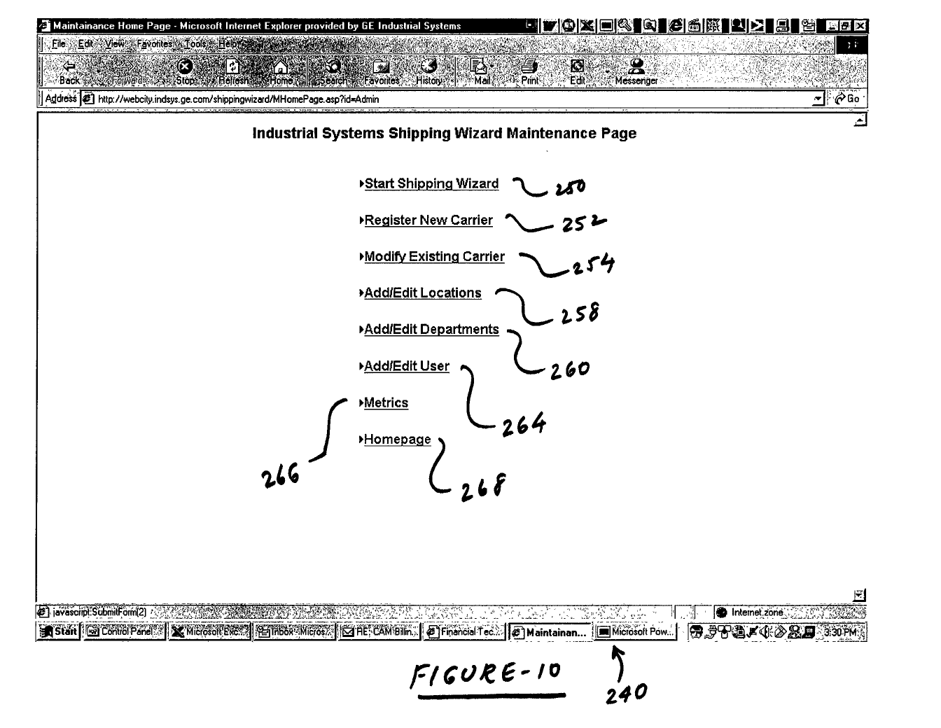

FIG. 10 is an exemplary embodiment of a Maintenance Page 240 of the shipping wizard displayed by system 10 (shown in FIG. 1) after the user has logged on to the system. Once the user logs on to the shipping wizard and selects a hypertext link “Maintenance Homepage” on user interface 100, system 10 downloads and displays Maintenance Page 240. Before system 10 grants the user access, the user is required to enter a User Id and a password to gain the access to the maintenance menu.

Maintenance Page 240 provides hypertext links to Start shipping wizard 250, Register a new Carrier 252, Modify details of an existing carrier 254, Delete a carrier (not shown), Add/Edit locations 258, Add/Edit departments 260, Add/Edit users 264, Metrics 266 and a hypertext link for Home Page 268.

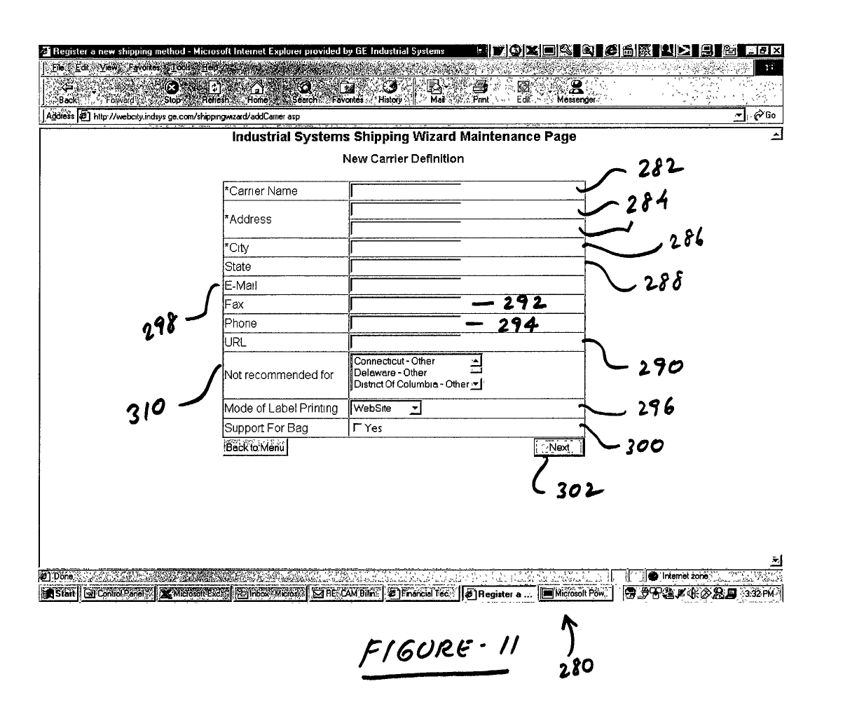

FIG. 11 is an exemplary embodiment of a first segment of a New Carrier Definition user interface 280 downloaded and displayed by server system 12 to register a new carrier when the user has selected Register a new carrier 252 hypertext link (shown in FIG. 10). New Carrier Definition user interface 280 is divided into several independent and connected user interfaces. Through user interface 280, the user is required to provide basic details such as a Carrier name 282, an address 284 including a name of a city 286 and a state 288 and a web site link through a URL 290. The required fields are marked with a ‘*’. If the user does not enter URL 290, the wizard provides a warning message which displays that the ‘URL must be entered’. Once the user inputs the information such as a Fax number 292, a Phone number 294, a Mode of Label Printing 296, an e-mail address 298, and a Support for Bag through marking a check box 300, the user moves to the next segment of New Carrier Definition user interface 280 by selecting a next button 302. The user also furnishes a list of cities or segments for which carrier 282 is not recommended 310. (URL 290 is a required field if the mode of label print 296 is selected as ‘Website’.) The user can change a mode of label 296 print by selecting from the provided list of values in the drop down box. The Back to Menu button takes the user back to Maintenance page 240 (shown in FIG. 10).

Once the user has completed inputting initial information on New Carrier Definition user interface 280 (shown in FIG. 11), the user provides a Shipping methods definition in detail through a second segment of New Carrier Definition user interface 280 (not shown). The user enters the shipping method (service type) details provided by the carrier (not shown in the Figure). The user further maps the shipping methods to a standard method that system can understand, e.g., next day, two day, three day. The latest delivery time needs to be selected for each method as provided by the carrier, such as whether the delivery is a Priority Overnight (PO), a Next day 10:30 am, or a Next Day 5:00 p.m. The user adds as many shipping methods as desired by the add row link (not shown).

Once the user has completed inputting the shipping methods definition, the user is directed to define shipping rates through a third segment of New Carrier Definition user interface 280 (not shown). System 10 allows the user to define the rates for all shipping methods defined for that carrier in the earlier page. The user enters the rates for a letter package by entering the rates in the row identified by the label Letter. The user skips entering rates wherever not available and adds the rates later using the link “Modify existing carrier” (not shown). In case a zero is entered in the rates box, the zero is not considered by the wizard during the query for optimum shipping method. Selecting the next button allows the user to define rates for the next set of 25 weights. The user defines rates for a maximum of 150 lbs.

The New Carrier Definition user interface 280 also requests a User ID, a password, and an account number for each department through a separate screen (not shown). The screen allows the user to define the User ID, the Password, and the account number created for that carrier for each department at a location. The User ID, password, and the account numbers are referred to as entities. The user selects a location before defining the values. The user can define new departments here, if desired by the user. New Carrier Definition User Interface 280 is the last screen of the “Define a new carrier” wizard. The user can define these values for multiple locations on the same page by selecting another location and defining the values. Selecting a finish button (not shown) completes the creation of a new carrier 282.

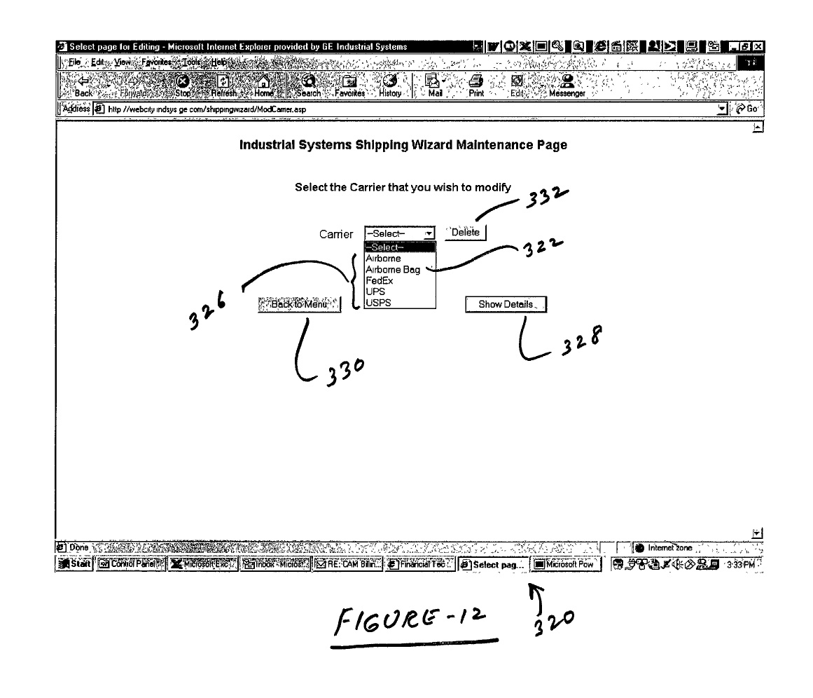

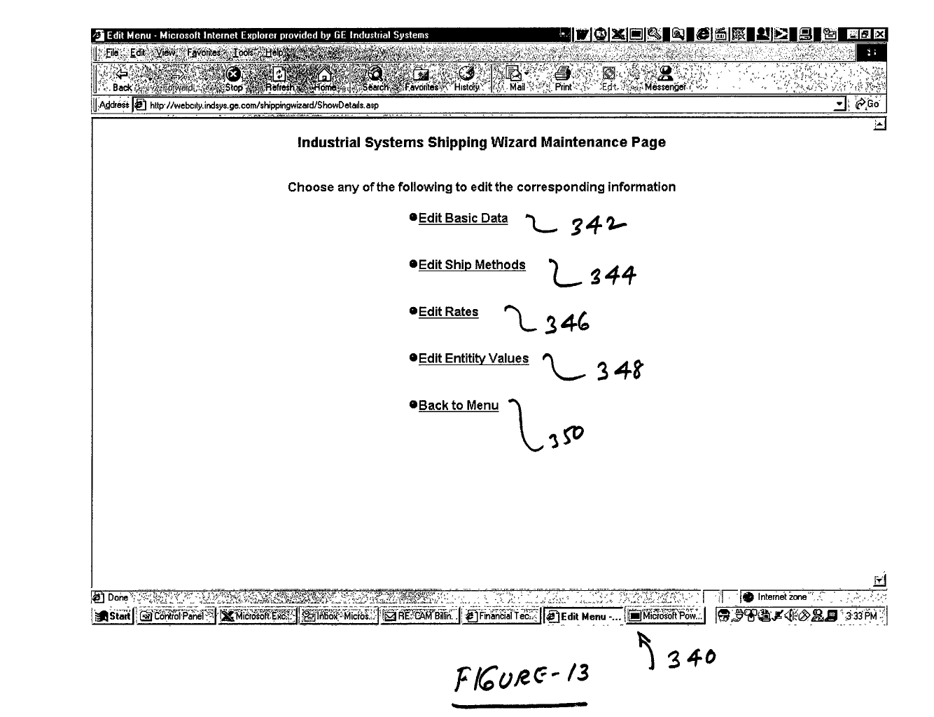

FIG. 12 is an exemplary embodiment of a Modify a carrier user interface 320 downloaded and displayed by server system 12 that allows the maintenance user to modify a carrier when the user has selected “Modify Existing Carrier” 254 hypertext link (shown in FIG. 10). Through user interface 320, the user selects a carrier 322 from a plurality of carriers 326 displayed. Once the user selects a carrier, the user selects a “Show details” button 328 which downloads a user interface (shown in FIG. 13) providing various other links to edit data, methods, rates and values relating to the selected carrier. A “Back to Menu” button 330 takes the user back to user interface 240 displayed in FIG. 10. If the user selects a carrier, and then selects a “Delete” button 332, the information stored in database 20 is deleted in its entirety.

FIG. 13 is an exemplary embodiment of a user interface 340 downloaded and displayed by server system 12 to allow the maintenance user to select a specific function when the user has selected “Show details” button 328 (shown in FIG. 12). Through user interface 340, the user can edit basic data 342 pertaining to a carrier, edit ship methods 344 such as add new service types, delete service types, etc., edit rates 346 for carriers, edit entities values 348, and edit User ID, password, and account information of each department pertaining to that carrier. A “Back to Menu” link 350 takes the user back to user interface 320 displayed in FIG. 12.

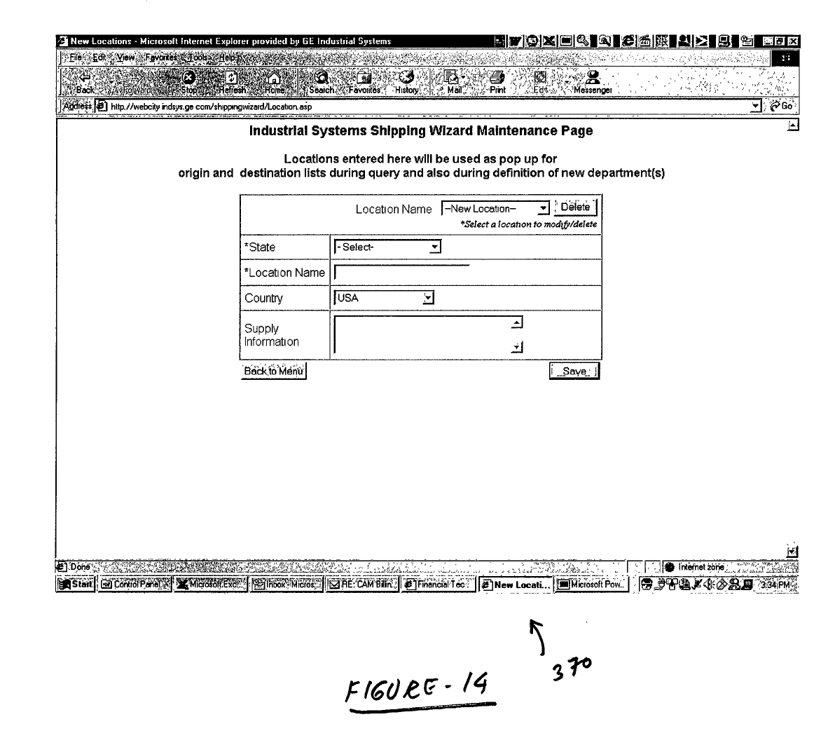

FIGS. 14 through 17 display the various user interfaces utilized by system 10 that provide maintenance capabilities to the user. For example, a user interface 370 displayed in FIG. 14 provides the user with a capability to modify or delete a specific location relating to a specific carrier identified.

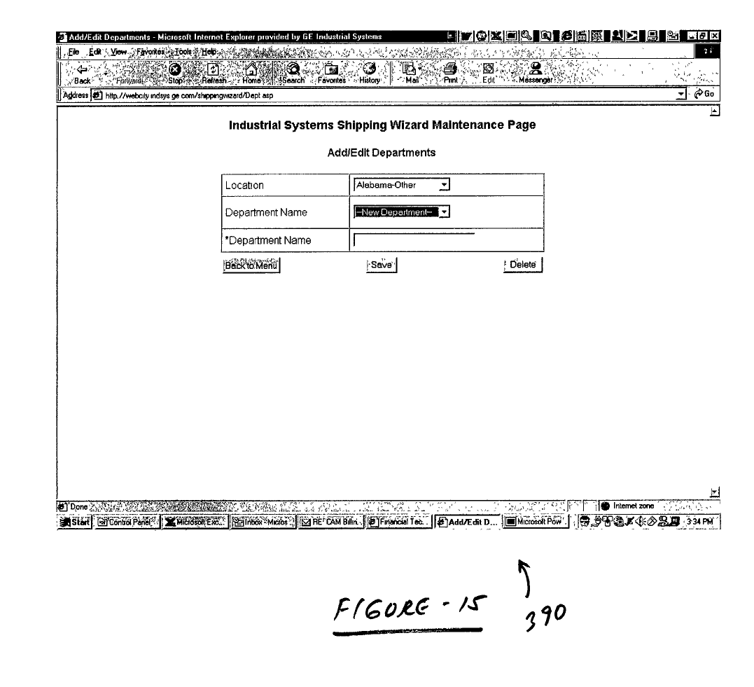

A user interface 390 displayed in FIG. 15 provides the user with a capability to add/edit departments. The user selects the location and then adds a new department or edits a current department.

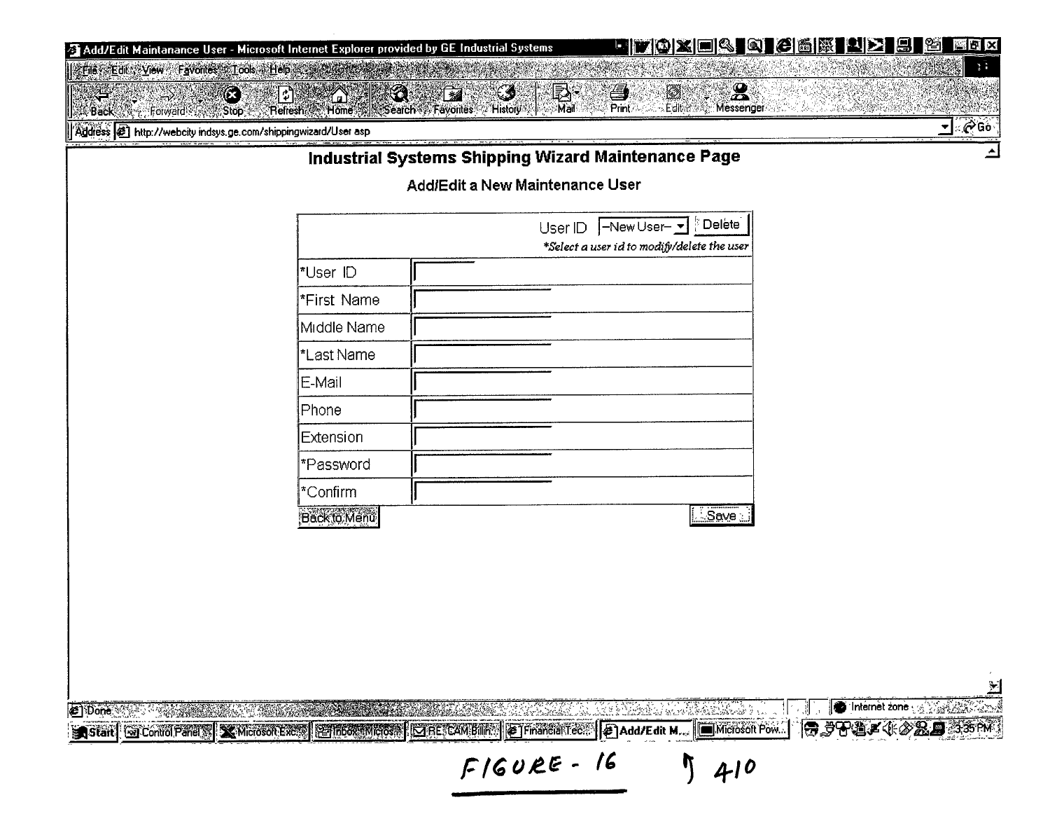

Another user interface 410, shown in FIG. 16, provides a capability to add/ edit a new maintenance user including a User ID, a first name, a middle name, a last name, an e-mail, a phone number, an extension, a password and other related details.

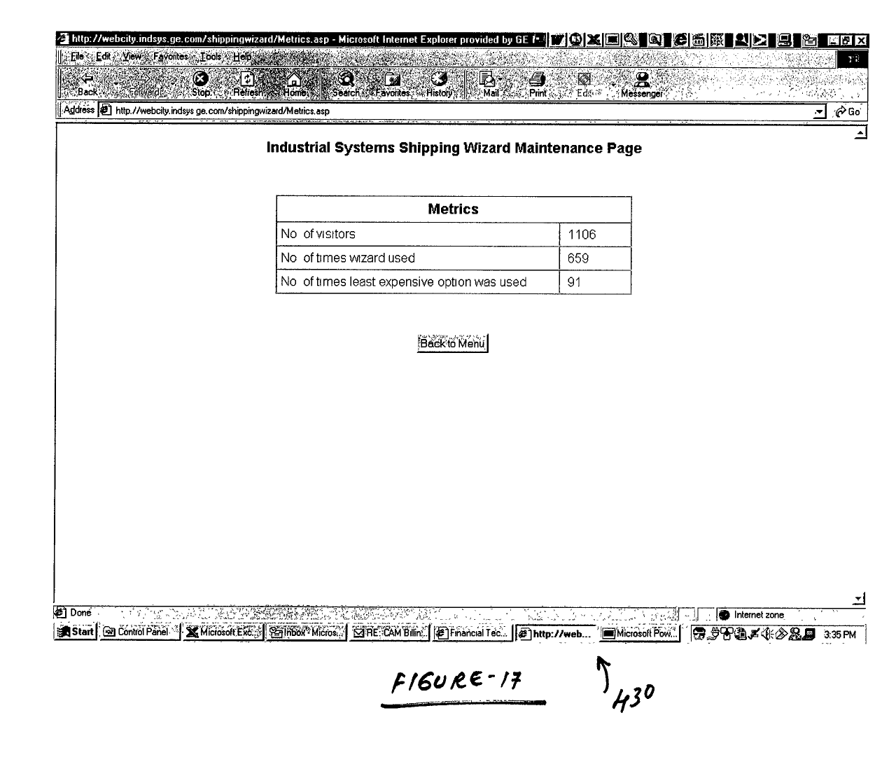

FIG. 17 is an exemplary embodiment of a user interface 430 that provides the system administrator with statistical details such as a number of visitors, number of times the shipping wizard has been used, and a number of times the least expensive option was utilized by the users.

Edit basic data link 342 (shown in FIG. 13) allows a user to edit any of the information of the carrier that exists in database 20. Selecting a save button (not shown) saves the edited information. Edit ship method link 344 allows the user to add new service types or delete service types. All the shipping methods (i.e. service types) are displayed with details. The user can change any of the information of the carrier and then select a save button to save the changed information. Similarly, the user can delete a service type by selecting the delete button adjacent that service.

Edit Rates link 346 (shown in FIG. 13) allows the user to change any of the rates of any service type for different weights. The user, can save the revised rates by selecting the save button.

Edit User ID, password, and account information of each department pertaining to that carrier requires the user to select one of the locations. The system displays a list of departments with User ID, Password and Account numbers for that location. The user can change any of the details and click on the save button to save the changed information.

Once the user selects “Add/Edit Locations” 258 hypertext link displayed in FIG. 10 on the maintenance homepage, server system 12 takes the user to a user interface (not shown) where user can define new locations or edit existing locations. The user needs to select a state from the dropdown menu, type in the location name, and select a country. The user then enters the supplies information text applicable at this location. The user can delete a location by selecting the location and clicking on the delete button. Once the location is deleted, the location will not be shown anywhere in the application. To edit a location the user needs to select the location from the dropdown menu of locations and fill out the new values and click on the save button.

While the invention has been described in terms of various specific embodiments, those skilled in the art will recognize that the invention can be practiced with modification within the spirit and scope of the claims.

What is claimed is:

1. A method for facilitating selection of at least one shipping carrier using a network-based system including a server and at least one device connected to the server via a network, said method comprising the steps of:
receiving shipping information from a user via the device;
comparing the received shipping information against pre-stored information;
selecting at least one shipping carrier which matches the received shipping information; and
displaying the selected shipping carrier based on the shipping information.

2. A method according to claim 1 wherein said step of receiving shipping information comprises the step of receiving at least one of a package type, a place of origin, a destination, a Latest delivery date, a Latest time, and a Weight of the package.

3. A method according to claim 2 wherein said step of selecting at least one shipping carrier comprises the steps of:
retrieving an optimum shipping carrier and associated costs; and
downloading the optimum shipping carrier and associated costs.

4. A method according to claim 1 wherein said step of displaying the selected shipping carrier based on the shipping information further comprises the steps of:
displaying at least one of a carrier, a rate, a shipping method and delivery times details of the optimum method; and
displaying at least one other alternative carrier including a name of the alternative carrier, a rate of the alternative carrier, a shipping method and delivery times details of the alternative carrier.

5. A method according to claim 1 wherein said step of receiving shipping information data from a user further comprises the step of receiving a user identification and a password for authentication purposes.

6. A method according to claim 1 wherein said step of displaying further comprises the steps of:
accessing a website of the shipping carrier; and
generating a shipping label on at least one of an attached printer and a network printer.

7. A method according to claim 1 wherein the shipping information is received from the user via a graphical user interface.

8. A method according to claim 1 further comprising the step of validating compatibility based on the received shipping information to determine whether a resulting optimum method is capable of meeting key parameters defined by a user.

9. A method according to claim 8 further comprising the step of guiding the user to the optimum shipping method.

10. A method for selecting at least one shipping carrier using a network-based system including a server coupled to a centralized database and at least one device connected to the server via a network, said method comprising the steps of:
authenticating a user based on a pre-defined criteria; and
launching at least one of a shipping wizard to select an optimum shipping method and a maintenance wizard to maintain the centralized database.

11. A method according to claim 10 wherein said step of authenticating further comprises an additional authentication procedure to the user before providing an access to the maintenance wizard.

12. The method according to claim 10 wherein the device and the server are connected via a network and wherein the network is one of a wide area network, a local area network, an intranet and the Internet.

13. A method for facilitating selection of at least one shipping carrier using a network-based system including a server coupled to a centralized database and at least one device connected to the server via a network, said method comprising the steps of:
accessing a maintenance user interface after a user has been authenticated based on pre-defined criteria; and
providing capabilities to the user to maintain the centralized database.

14. A method according to claim 13 wherein said step of providing capabilities further comprises the steps of providing at least one of a functionality that permits the user to register a new carrier, modify an existing carrier, add locations, edit locations, add departments, edit department profiles, add users, and edit user profiles.

15. A method according to claim 14 wherein said step of providing capabilities further comprises the steps of downloading and displaying various performance metrics.

16. A web-based shipping system for facilitating selection of at least one shipping carrier, said system comprising:
a client sub-system comprising a browser;
a centralized database for storing carrier information;
a server sub-system configured to be coupled to said client sub-system and said database, said server sub-system further configured to:
receive shipping information from a user via the client system;
compare the received shipping information against pre-stored information;
select at least one shipping carrier which matches the received shipping information; and
display the selected shipping carrier based on the shipping information.

17. A system according to claim 16 wherein said client system is configured with:
a displaying component for displaying at least one of a home page user interface, an input interface, a user interface displaying an optimum shipping method, a user interface displaying alternative options, a user interface displaying the user's final selection, and a user interface that facilitates printing of a label;
a displaying component for displaying at least one of a user interface to access maintenance home page, register a new carrier, modify an existing carrier, add locations, edit locations, add departments, edit department profiles, add users, and edit user profiles, and
a sending component for sending an inquiry to the server system so that the server system can process and download the requested information to the client system.

18. A system according to claim 17 wherein the sending component functions in response to a click of a mouse button.

19. A system according to claim 17 wherein the sending component functions in response to a voice command.

20. A system according to claim 17 wherein said system is further configured to be protected from access by unauthorized individuals.

21. A system according to claim 17 wherein said server system is further configured with:
a collection component for collecting information from users into the centralized database;
a tracking component for tracking information on an on-going basis;
a displaying component for displaying at least one of a home page user interface, an input interface, a user interface displaying an optimum shipping method, a user interface displaying alternative options, a user interface displaying the user's final selection, and a user interface that facilitates printing of a label;
a displaying component for displaying at least one of a user interface to access maintenance home page, register a new carrier, modify an existing carrier, add locations, edit locations, add departments, edit department profiles, add users, and edit user profiles;
a receiving component for receiving an inquiry from the client system; and
an accessing component for accessing the centralized database and causing the retrieved information to be displayed on the client system.

22. A system according to claim 21 wherein said server system further configured with a receiving component for receiving an inquiry to provide information from one of a plurality of users.

23. A system according to claim 21 wherein said server system further configured with a processing component for searching and processing received inquiries against the data storage device containing a variety of information collected by the collection component.

24. A system according to claim 21 wherein said server system further configured with a retrieving component to retrieve information from the database.

25. A system according to claim 21 wherein said server system further configured with an information fulfillment component that downloads the requested information after retrieving from the database to the plurality of users in the order in which the requests were received by the receiving component.

26. A system according to claim 16 wherein said server system further configured to:
receive at least one of a package type, a place of origin, a destination, a latest delivery date, a latest time, and a weight of the package;
update the carrier information including at least one of a carrier, modify an existing carrier, add locations of the carrier, edit locations of the carrier, add departments, edit department profiles, add users, and edit user profiles; and
store updated carrier information in the database.

27. A system according to claim 16 wherein said server system further configured to enter information at least through one of a voice activation command and a device connected to the client system.

28. A system according to claim 16 wherein said server system further configured to store the updated carrier information against an identifier.

29. A system according to claim 16 wherein said server system further configured to:
track the carrier information on a real time basis; and
store the carrier information on a real time basis by updating stored information by adding the new information to the centralized database on a real time basis to provide up-to-date carrier information instantaneously to the user upon a request.

30. A system according to claim 16 wherein said server system further configured to:
download requested information from a server system; and
display requested information on a client system in response to the inquiry.

31. A system according to claim 30 wherein said server system further configured to print the requested information in a pre-determined format.

32. A system according to claim 16 wherein said server system further configured to accept an inquiry from a user.

33. A system according to claim 32 wherein said server system further configured to:
receive an inquiry from the client system; and
display information on the client system.

34. A system according to claim 33 wherein said server system further configured to submit a request through at least one of pull down menus, check boxes, and hypertext links.

35. A system according to claim 33 wherein said server system further configured to display an HTML document downloaded by the server system.

36. A system according to claim 33 wherein said server system further configured to display at least one alternative from various alternatives available to the user.

37. A system according to claim 30 wherein said server system further configured to:
access the centralized database;
search the database regarding the specific inquiry;
retrieve information from the database; and
transmit the retrieved information to the client system for display by the client system.

38. A system according to claim 16 wherein said server system further configured to accept a request for maintenance home page after the user has been authenticated against pre-determined criteria.

39. A system according to claim 16 wherein said client system configured to be a server for a network of customer devices.

40. A system according to claim 16 wherein said network is one of a wide area network, a local area network an intranet and the Internet.
